(19) United States
(12) Patent Application Publication
(10) Pub. No.: US 2017/0287642 A1
(43) Pub. Date: Oct. 5, 2017

(54) MULTI-LAYER CERAMIC ELECTRONIC COMPONENT AND METHOD OF PRODUCING THE SAME

(71) Applicant: TAIYO YUDEN CO. LTD., Tokyo (JP)

(72) Inventors: Ryo ONO, Tokyo (JP); Tetsuhiko FUKUOKA, Tokyo (JP)

(73) Assignee: TAIYO YUDEN CO. LTD., Tokyo (JP)

(21) Appl. No.: 15/471,755

(22) Filed: Mar. 28, 2017

(30) Foreign Application Priority Data
Mar. 30, 2016 (JP) 2016-067671

(51) Int. Cl. H01G 4/30; H01G 4/12; H01G 4/008; H01G 4/012; H01G 4/232

(52) U.S. Cl. CPC H01G 4/30; H01G 4/012; H01G 4/2325; H01G 4/008; H01G 4/12

(57) ABSTRACT

A multi-layer ceramic capacitor, including a multi-layer including internal electrodes and dielectric layers alternately laminated, the internal electrodes having ends protruding beyond the dielectric layers in surface directions thereof; and side protective layers configured of a dielectric and disposed to cover side faces of the multi-layer, the side protective layers each having spacing sections formed between the ends of the internal electrodes.

### CROSS-REFERENCE TO RELATED APPLICATIONS

This application claims the benefit of Japanese Priority Patent Application JP 2016-067671 filed Mar. 30, 2016, the entire contents of which are incorporated herein by reference.

### BACKGROUND

Aspects of the present invention relate to a multi-layer ceramic electronic component including side margins provided in a subsequent step, and to a method of producing the multi-layer ceramic electronic component.

Along with miniaturization and achievement of high performance of electronic devices, recently, there have been increasingly strong demands for miniaturization, increase in capacity, ensuring of reliability, and the like with respect to multi-layer ceramic capacitors used in the electronic devices. In order to meet those demands, it is effective to enlarge an intersectional area of internal electrodes of the multi-layer ceramic capacitor as much as possible.

For example, Japanese Patent Application Laid-open Nos. 2014-143392 and 2014-204113 disclose techniques of forming side margins on a multi-layer chip in a subsequent step, the multi-layer chip including internal electrodes exposed on side surfaces of the multi-layer chip, the side margins being used for ensuring insulation properties of the periphery of the internal electrodes. Those techniques make it possible to form thin side margins and relatively increase an intersectional area of the internal electrodes.

### SUMMARY

However, in the inventions described in Japanese Patent Application Laid-open Nos. 2014-143392 and 2014-204113, adhesion of foreign substances derived from the internal electrodes to the side surfaces of the multi-layer chip, drag of the internal electrodes by a cutting blade, and the like may be caused in the production process. For those reasons, the internal electrodes may be electrically conducted and a short circuit failure between the internal electrodes may occur in the side surface of a sintered body.

In view of the circumstances as described above, it is desirable to provide a multi-layer ceramic electronic component and a method of producing the multi-layer ceramic electronic component, which are capable of preventing a short circuit failure from occurring between internal electrodes.

It is possible to provide a multi-layer ceramic electronic component and a method of producing the multi-layer ceramic electronic component, which are capable of preventing a short circuit failure from occurring between internal electrodes.

These and/or other objects, features and advantages of the present invention will become more apparent in light of the following detailed description of embodiments thereof, as illustrated in the accompanying drawings.

### BRIEF DESCRIPTION OF DRAWINGS

FIG. 1 is a perspective view of a multi-layer ceramic capacitor according to one embodiment of the present invention;

FIG. 2 is a cross-sectional view of the multi-layer ceramic capacitor taken along the A-A′ line in FIG. 1;

FIG. 3 is a cross-sectional view of the multi-layer ceramic capacitor taken along the B-B′ line in FIG. 1;

FIG. 4 is an enlarged schematic view of an area P of the multi-layer ceramic capacitor shown in FIG. 3;

FIG. 5 is a flowchart showing a method of producing the multi-layer ceramic capacitor;

FIG. 6A is a plan view showing a production process of the multi-layer ceramic capacitor;

FIG. 6B is a plan view showing the production process of the multi-layer ceramic capacitor;

FIG. 6C is a plan view showing the production process of the multi-layer ceramic capacitor;

FIG. 7 is an exploded perspective view showing the production process of the multi-layer ceramic capacitor;

FIG. 8 is a plan view showing the production process of the multi-layer ceramic capacitor;

FIG. 9 is a perspective view showing the production process of the multi-layer ceramic capacitor;

FIG. 10 is a cross-sectional view of a multi-layer chip in the production process of the multi-layer ceramic capacitor; and

FIG. 11 is a perspective view showing the production process of the multi-layer ceramic capacitor.

### DETAILED DESCRIPTION OF EMBODIMENTS

Hereinafter, an embodiment of the present invention will be described with reference to the drawings.

In the figures, an X axis, a Y axis, and a Z axis orthogonal to one another are shown as appropriate. The X axis, the Y axis, and the Z axis are common in all figures.

### 1. First Embodiment

1.1 Overall Configuration of Multi-Layer Ceramic Capacitor 10

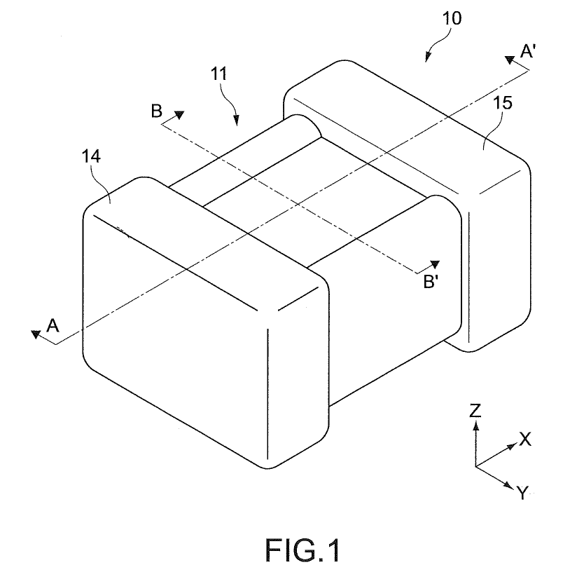

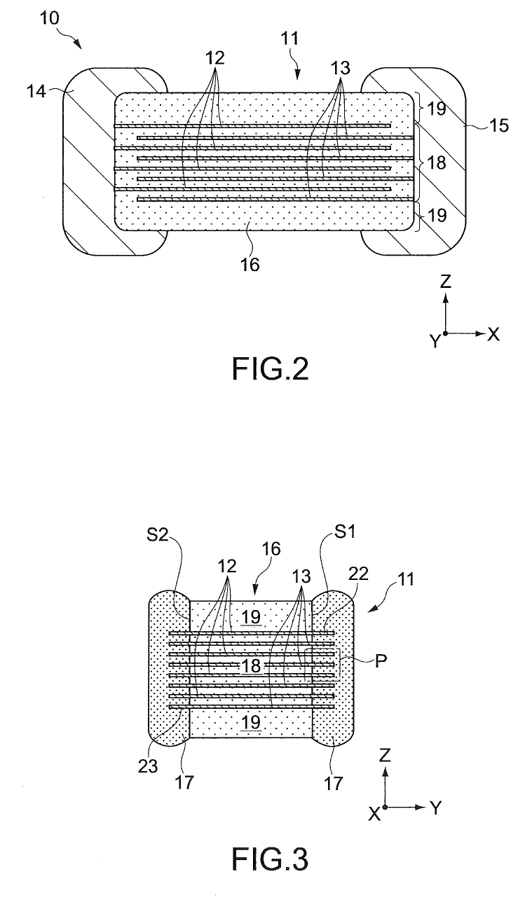

FIGS. 1 to 3 show a multi-layer ceramic capacitor 10 according to one embodiment of the present invention. FIG. 1 is a perspective view of the multi-layer ceramic capacitor 10. FIG. 2 is a cross-sectional view of the multi-layer ceramic capacitor 10 taken along the A-A line in FIG. 1. FIG. 3 is a cross-sectional view of the multi-layer ceramic capacitor 10 taken along the B-B′ line in FIG. 1.

The multi-layer ceramic capacitor 10 includes a body 11, a first external electrode 14, and a second external electrode 15.

Typically, the body 11 has two side surfaces oriented in a Y-axis direction and two main surfaces oriented in a Z-axis direction. Ridges connecting the respective surfaces of the body 11 are chamfered. It should be noted that the form of the body 11 is not limited to the form as described above. For example, the surfaces of the body 11 may be curved surfaces, and the body 11 may be rounded as a whole.

The first external electrode 14 and the second external electrode 15 cover both end surfaces of the body 11 that are oriented in an X-axis direction, and extend to four surfaces that are connected to both the end surfaces oriented in the X-axis direction. With this configuration, both of the first external electrode 14 and the second external electrode 15 have U-shaped cross sections in parallel with an X-Z plane and an X-Y plane.

The body 11 includes a multi-layer unit 16 and side margins 17.

The multi-layer unit 16 has a configuration in which a plurality of flat plate-like ceramic layers extending along the X-Y plane is laminated in the Z-axis direction.

The multi-layer unit 16 includes a capacitance forming unit 18 and covers 19.

The capacitance forming unit 18 includes a plurality of first internal electrodes 12 and a plurality of second internal electrodes 13. The first internal electrodes 12 and the second internal electrodes 13 are alternately disposed between the ceramic layers along the Z-axis direction. The first internal electrodes 12 are connected to the first external electrode 14 and are insulated from the second external electrode 15. The second internal electrodes 13 are connected to the second external electrode 15 and are insulated from the first external electrode 14.

The first internal electrodes 12 and the second internal electrodes 13 are each made of an electrical conductive material and function as internal electrodes of the multi-layer ceramic capacitor 10. Examples of the electrical conductive material include nickel (Ni), copper (Cu), palladium (Pd), platinum (Pt), silver (Ag), gold (Au), and a metal material including an alloy of them. Typically, a metal material containing nickel (Ni) as a main component is used.

The capacitance forming unit 18 is made of ceramics. In the capacitance forming unit 18, in order to increase capacitances of the ceramic layers provided between the first internal electrodes 12 and the second internal electrodes 13, a material having a high dielectric constant is used as a material forming the ceramic layers. For the capacitance forming unit 18, polycrystal of a barium titanate (BaTiO₃) based material, i.e., polycrystal having a Perovskite structure containing barium (Ba) and titanium (Ti) can be used, for example.

Alternatively, the capacitance forming unit 18 may be made of polycrystal of a strontium titanate (SrTiO₃) based material, a calcium titanate (CaTiO₃) based material, a magnesium titanate (MgTiO₃) based material, a calcium zirconate (CaZrO₃) based material, a calcium zirconate titanate (Ca(Zr,Ti)O₃) based material, a barium zirconate (BaZrO₃) based material, a titanium oxide (TiO₂) based material, or the like.

The covers 19 each has a plate-like shape extending along the X-Y plane and cover the upper and lower surfaces of the capacitance forming unit 18 in the Z-axis direction. The covers 19 do not include the first internal electrodes 12 and the second internal electrodes 13.

As shown in FIG. 3, the side margins 17 are formed on both side surface S1 and S2 of the capacitance forming unit 18 and the covers 19. The both side surface S1 and S2 are oriented in the Y-axis direction.

In such a manner, in the body 11, except for both the end surfaces, which are oriented in the X-axis direction and to which the first external electrode 14 and the second external electrode 15 are provided, surfaces of the capacitance forming unit 18 are covered with the side margins 17 and the covers 19. The side margins 17 and the covers 19 have main functions of protecting the periphery of the capacitance forming unit 18 and ensuring insulation properties of the first internal electrodes 12 and the second internal electrodes 13.

The side margins 17 and the covers 19 are also made of ceramics. The material of the side margins 17 and the covers 19 are insulating ceramics. Use of ceramics including a composition system, which is common to a composition system of the capacitance forming unit 18, leads to suppression of internal stress in the body 11.

The side margins 17 according to this embodiment may also contain magnesium (Mg) in addition to barium (Ba) and titanium (Ti). Further, the capacitance forming unit 18 and the covers 19 may also contain magnesium (Mg) in addition to barium (Ba) and titanium (Ti).

Furthermore, the side margins 17, the capacitance forming unit 18, and the covers 19 may contain manganese (Mn), nickel (Ni), lithium (Li), silicon (Si), an oxide of them, or the like instead of the elements described above.

With the configuration described above, when a voltage is applied between the first external electrode 14 and the second external electrode 15 in the multi-layer ceramic capacitor 10, a voltage is applied to the plurality of ceramic layers between the first internal electrodes 12 and the second internal electrodes 13. With this configuration, the multi-layer ceramic capacitor 10 stores charge corresponding to the voltage applied between the first external electrode 14 and the second external electrode 15.

It should be noted that the multi-layer ceramic capacitor 10 according to this embodiment only needs to include the multi-layer unit 16 and the side margins 17, and other configurations can be changed as appropriate. For example, the number of first internal electrodes 12 and second internal electrodes 13 can be determined as appropriate in accordance with the size and performance expected for the multi-layer ceramic capacitor 10.

Further, in FIGS. 2 and 3, in order to make the facing state of the first and second internal electrodes 12 and 13 easily viewable, the number of first internal electrodes 12 and the number of second internal electrodes 13 are each set to four. However, actually, more first and second internal electrodes 12 and 13 are generally provided so as to ensure the capacitance of the multi-layer ceramic capacitor 10.

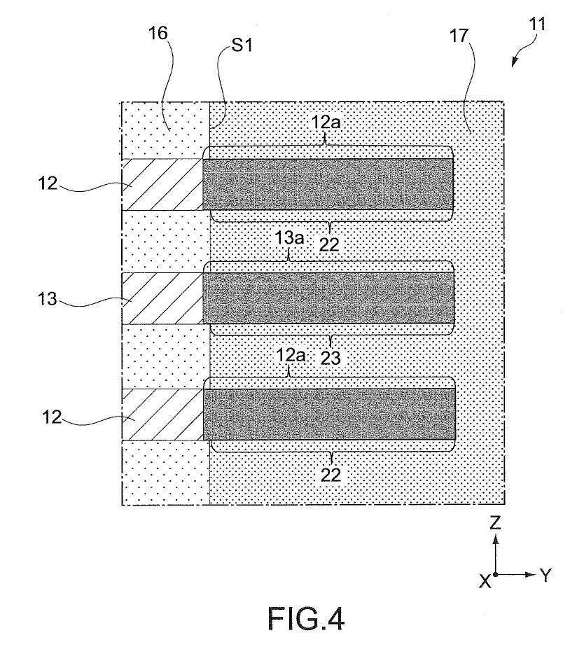

FIG. 4 is an enlarged schematic view of an area P shown in FIG. 3. As shown in FIG. 4, the first internal electrode 12 and the second internal electrode 13 include a protruding portion 22 and a protruding portion 23, respectively. The protruding portion 22 and the protruding portion 23 protrude beyond dielectric layers (ceramic sheets) in surface directions thereof. Here, the side margin 17 according to this embodiment covers the protruding portions 22 and 23 as shown in FIG. 4.

With this configuration, the protruding portions 22 and the protruding portions 23 that are adjacent to each other in the Z-axis direction are apart from each other via the side margin 17. Thus, the multi-layer ceramic capacitor 10 has a configuration in which a short circuit failure or an insulation resistance (IR) failure between the first internal electrodes 12 and the second internal electrodes 13 in the side surfaces S1 and S2 of the multi-layer unit 16, and the like are difficult to occur.

Further, as shown in FIG. 4, the first internal electrode 12 and the second internal electrode 13 include an oxidized area 12a and an oxidized area 13a, respectively. The oxidized area 12a and the oxidized area 13a are areas with electrical conductivity reduced by oxidation. Each of the oxidized areas 12a and 13a typically includes an oxide containing nickel (Ni) and magnesium (Mg). With this configuration, also when the protruding portion 22 and the protruding portion 23 come close to or come into contact with each other, electrical conduction between the first internal electrode 12 and the second internal electrode 13 is suppressed. Thus, the multi-layer ceramic capacitor 10 has a configuration in which a short circuit failure between the first internal electrodes 12 and the second internal electrodes 13 is further difficult to occur. It should be noted that the oxidized areas 12a and 13a may be formed at part or all of the protruding portions 22 and 23.

The length of the protruding portions 22 and 23 in the Y-axis direction is not particularly limited, but is suitably 0.3 μm or more and 4 μm or less, and more suitably, 0.8 μm or more and 2 μm or less. With this configuration, the multi-layer ceramic capacitor 10 has a configuration in which generation of a short circuit failure or an IR failure between the first internal electrodes 12 and the second internal electrodes 13 is suppressed while a desired electrostatic capacitance is ensured.

1.2 Method of Producing Multi-Layer Ceramic Capacitor 10

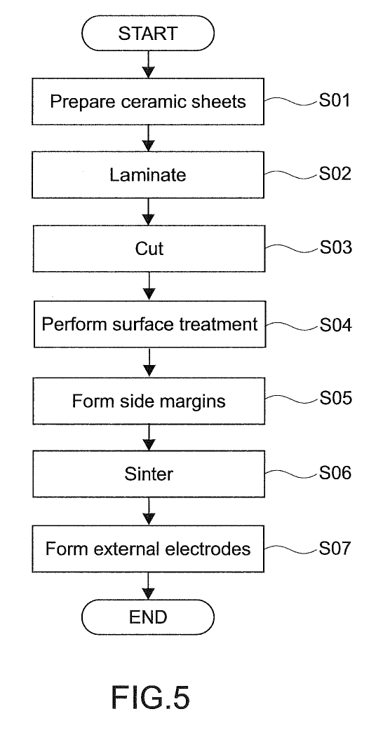

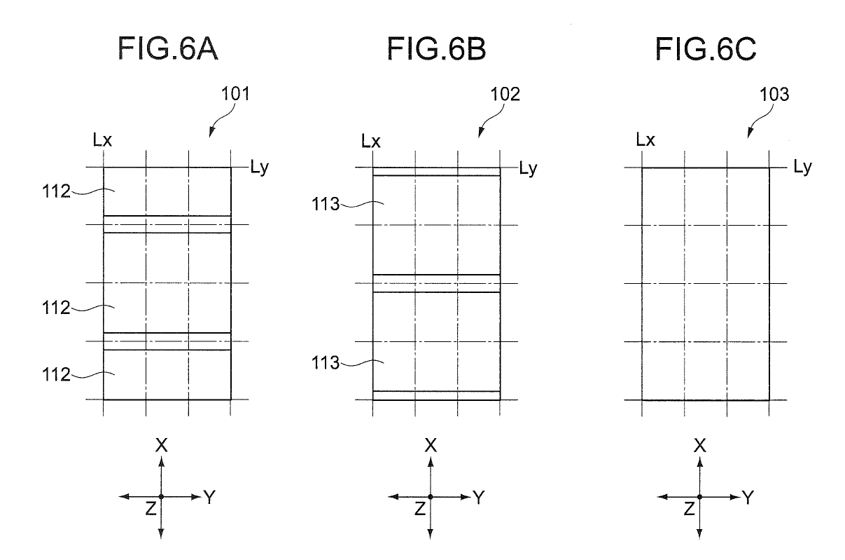

FIG. 5 is a flowchart showing a method of producing the multi-layer ceramic capacitor 10. FIGS. 6A to 11 are views showing a production process of the multi-layer ceramic capacitor 10. Hereinafter, the method of producing the multi-layer ceramic capacitor 10 will be described along FIG. 5 with reference to FIGS. 6A to 11 as appropriate.

1.2.1 Step S01: Preparation of Ceramic Sheets

In Step S01, first ceramic sheets 101 and second ceramic sheets 102 for forming the capacitance forming unit 18, and third ceramic sheets 103 for forming the covers 19 are prepared. The first, second, and third ceramic sheets 101, 102, and 103 are configured as unsintered dielectric green sheets and formed into sheets by using a roll coater or a doctor blade, for example.

FIGS. 6A, 6B, and 6C are plan views of the first, second, and third ceramic sheets 101, 102, and 103, respectively. At this stage, the first, second, and third ceramic sheets 101, 102, and 103 are not yet cut into the multi-layer ceramic capacitors 10. FIGS. 6A, 6B, and 6C each show cutting lines Lx and Ly used when the sheets are cut into the multi-layer ceramic capacitors 10. The cutting lines Lx are parallel to the X axis, and the cutting lines Ly are parallel to the Y axis.

As shown in FIGS. 6A, 6B, and 6C, unsintered first internal electrodes 112 corresponding to the first internal electrodes 12 are formed on the first ceramic sheet 101, and unsintered second internal electrodes 113 corresponding to the second internal electrodes 13 are formed on the second ceramic sheet 102. It should be noted that no internal electrodes are formed on the third ceramic sheet 103 corresponding to the cover 19.

The first and second internal electrodes 112 and 113 can be formed using an electrical conductive paste containing nickel (Ni), for example. For formation of the first and second internal electrodes 112 and 113 by use of an electrical conductive paste, a screen printing method or a gravure printing method can be used, for example.

Each of the first and second internal electrodes 112 and 113 is disposed over two areas and extends like a belt in the Y-axis direction. The two areas are adjacent to each other in the X-axis direction and divided by the cutting line Ly. The first internal electrodes 112 are shifted from the second internal electrodes 113 in the X-axis direction by one row including the areas divided by the cutting lines Ly. In other words, the cutting line Ly passing through the center of the first internal electrode 112 passes through an area between the second internal electrodes 113, and the cutting line Ly passing through the center of the second internal electrode 113 passes through an area between the first internal electrodes 112.

1.2.2 Step S02: Lamination

In Step S02, the first, second, and third ceramic sheets 101, 102, and 103 prepared in Step S01 are laminated, to produce a multi-layer sheet 104.

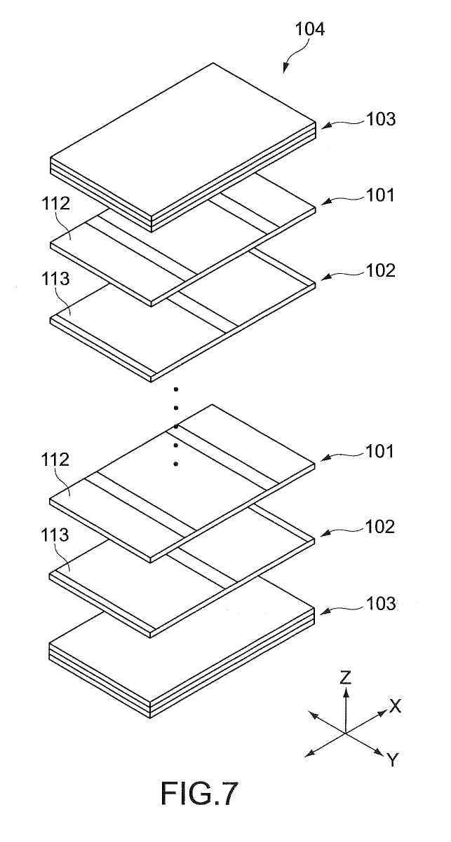

FIG. 7 is an exploded perspective view of the multi-layer sheet 104 obtained in Step S02. For the purpose of description, FIG. 7 shows the first, second, and third ceramic sheets 101, 102, and 103 in an exploded manner. In an actual multi-layer sheet 104, however, the first, second, and third ceramic sheets 101, 102, and 103 are pressure-bonded by hydrostatic pressing, uniaxial pressing, or the like for integration. With this configuration, a high-density multi-layer sheet 104 is obtained.

In the multi-layer sheet 104, the first ceramic sheets 101 and the second ceramic sheets 102 that correspond to the capacitance forming unit 18 are alternately laminated in the Z-axis direction.

Further, in the multi-layer sheet 104, the third ceramic sheets 103 corresponding to the covers 19 are laminated on the uppermost and lowermost surfaces of the first and second ceramic sheets 101 and 102 alternately laminated in the Z-axis direction. It should be noted that in the example shown in FIG. 7, three third ceramic sheets 103 are laminated on each of the uppermost and lowermost surfaces of the laminated first and second ceramic sheets 101 and 102, but the number of third ceramic sheets 103 can be changed as appropriate.

1.2.3 Step S03: Cutting

In Step S03, the multi-layer sheet 104 obtained in Step S02 is cut with a rotary blade, a push-cutting blade, or the like, to produce unsintered multi-layer chips 116.

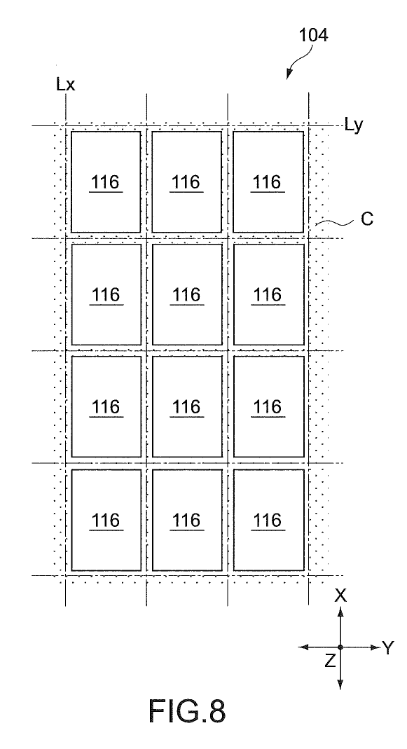

FIG. 8 is a plan view of the multi-layer sheet 104 after Step S03. The multi-layer sheet 104 is cut along the cutting lines Lx and Ly while being fixed to a holding member C. With this configuration, the multi-layer sheet 104 is singulated, so that the multi-layer chips 116 are obtained. At that time, the holding member C is not cut, and thus the multi-layer chips 116 are connected via the holding member C.

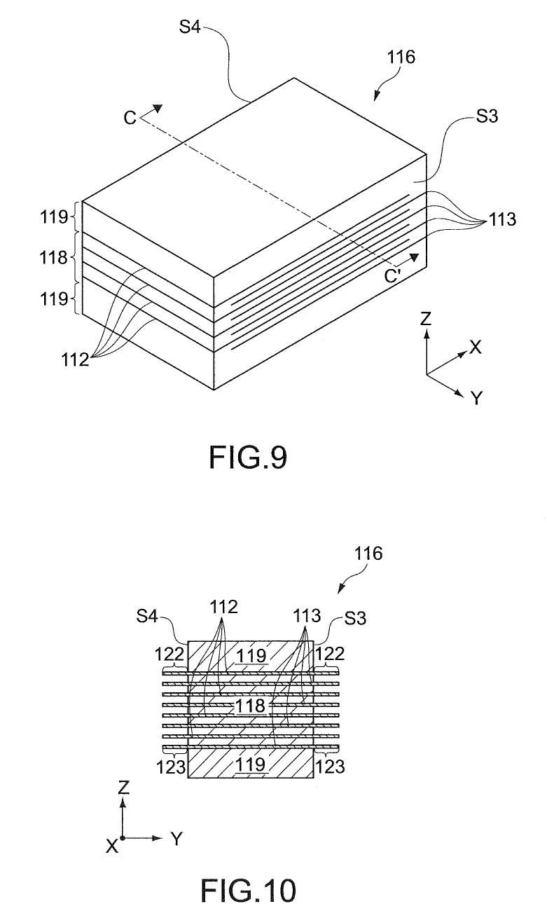

FIG. 9 is a perspective view of the multi-layer chip 116 obtained in Step S03. The multi-layer chip 116 includes a capacitance forming unit 118 and covers 119 that are unsintered. In the multi-layer chip 116, the unsintered first and second internal electrodes 112 and 113 are exposed on the cut surfaces, i.e., both the side surfaces S3 and S4 oriented in the Y-axis direction.

1.2.4 Step S04: Surface Treatment

In Step S04, surface treatment is performed on the multi-layer chip 116 (capacitance forming unit 118 and covers 119) obtained in Step S03, from the cut surfaces described above, i.e., the side surfaces S3 and S4 oriented in the Y-axis direction.

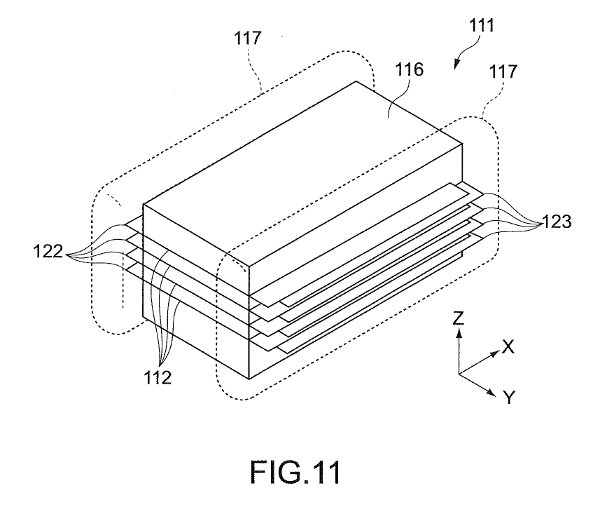

FIG. 10 is a cross-sectional view of the multi-layer chip 116 obtained in Step S04. As shown in FIG. 10, protruding portions 122 and protruding portions 123 are formed. The first internal electrodes 112 and the second internal electrodes 113 respectively in the protruding portions 122 and protruding portions 123 protrude beyond the dielectric layers (ceramic sheets 101, 102, 103, etc.) in surface directions of the multi-layer chip 116 obtained after the surface treatment.

Further, even if there are scratches caused by a cutting blade, attached substances derived from the first and second internal electrodes 112 and 113, and the like on the side surfaces S3 and S4 of the multi-layer chip 116 obtained after Step S03, the scratches and attached substances can be removed by the surface treatment. Thus, electrical conduction between the first internal electrodes 112 and the second internal electrodes 113 in the side surfaces S3 and S4 due to the above-mentioned scratches and attached substances can be suppressed. In other words, it is possible to provide a multi-layer ceramic capacitor 10 capable of preventing a short circuit failure from occurring between the first internal electrodes 112 and the second internal electrodes 113.

Examples of the surface treatment to be employed include polishing and etching. A polishing method is not particularly limited and may be, for example, barrel polishing using the multi-layer chip 116 and an abrasive medium, sandblasting of spraying abrasive powder to both the side surfaces S3 and S4 of the multi-layer chip 116, on which the unsintered first and second internal electrodes 112 and 113 are exposed, to perform polishing, and other methods.

An etching method is not also limited. For example, a method of immersing each of the side surfaces S3 and S4 in acid for a predetermined time may be used. In this case, an etchant used for the etching may be an etchant that dissolves the ceramics forming the capacitance forming unit 118 and the covers 119 and does not dissolve the first and second internal electrodes 112 and 113. For example, a hydrofluoric acid and the like can be used. With this configuration, the capacitance forming unit 118 and the covers 119 are selectively etched from both the side surfaces S3 and S4 of the multi-layer chip 116, to form the protruding portions 122 and 123.

It should be noted that only the above-mentioned side surfaces S3 and S4 oriented in the Y-axis direction are desirably immersed in the etchant such that the end surfaces of the multi-layer chip 116 that are oriented in the X-axis direction are not etched. Alternatively, the end surfaces of the multi-layer chip 116 that are oriented in the X-axis direction may be masked, and the multi-layer chip 116 may be immersed in the etchant.

In Step S04, the surface treatment using the approach as described above is performed on both the side surfaces S3 and S4 of the multi-layer chip 116. Thus, the length of the side margins 17 covering the protruding portions 22 and 23 in the Y-axis direction can be controlled. In other words, the length of the protruding portions 22 and 23 in the Y-axis direction can be set to an optional length.

1.2.5 Step S05: Formation of Side Margins

In Step S05, unsintered side margins 117 are provided on the side surfaces S3 and S4 of the multi-layer chip 116 obtained after the surface treatment in Step S04, and an unsintered body 111 is produced.

The side margins 117 according to this embodiment can be formed by immersing and then pulling out the side surfaces S3 and S4 of the multi-layer chip 116 obtained after the surface treatment in and from a paste material made of ceramics containing magnesium (Mg) (dip method). With this configuration, the multi-layer chip 116 obtained after Step S05 has a configuration in which the side surfaces S3 and S4 and the protruding portions 122 and 123 are covered with the side margins 117 and the protruding portions 122 and 123 are apart from one another.

It should be noted that a method of forming the side margins 117 in Step S05 may be a method capable of successfully covering the protruding portions 122 and 123, and is not limited to the dip method described above. Examples of a method capable of forming the side margins 117 include a spray dry method, except for the dip method.

FIG. 11 is a perspective view of the unsintered body 111 obtained in Step S05. FIG. 11 shows the multi-layer chip 116 with the side margins 117 being indicated by broken lines to be transparent. Step S05 is performed after Step S04, and thus the protruding portions 122 and 123 are covered with the side margins 117.

1.2.6 Step S06: Sintering

In Step S06, the unsintered body 111 obtained in Step S05 is sintered to produce the body 11 of the multi-layer ceramic capacitor 10 shown in FIGS. 1 to 3.

In other words, in Step S06, the first and second internal electrodes 112 and 113 become the first and second internal electrodes 12 and 13, and the protruding portions 122 and 123 become the protruding portions 22 and 23. Further, the multi-layer chip 116 becomes the multi-layer unit 16, and the side margins 117 become the side margins 17.

A sintering temperature for the body 111 in Step S06 can be determined on the basis of a sintering temperature for the multi-layer chip 116 and the side margins 117. For example, when a barium titanate (BaTiO₃) based material is used as the ceramics, the sintering temperature for the body 111 can be set to approximately 1,000 to 1,300° C. Further, sintering can be performed in a reduction atmosphere or a low-oxygen partial pressure atmosphere, for example.

Here, the protruding portions 122 and 123 of the body 111 according to this embodiment are covered with the side margins 117 containing magnesium (Mg).

Nickel (Ni) contained in the first and second internal electrodes 112 and 113 is likely to be oxidized when being coupled to magnesium (Mg) contained in the side margins 117 at the sintering. As a result, the first and second internal electrodes 112 and 113 at the sintering are likely to generate an oxide containing nickel (Ni) and magnesium (Mg) particularly in the protruding portions 122 and 123. Thus, since the protruding portions 122 and 123 can be easily oxidized, the action and effect described above can be obtained.

It should be noted that a method of oxidizing the protruding portions 122 and 123 of the first and second internal electrodes 112 and 113 may be another method.

1.2.7 Step S07: Formation of External Electrodes

In Step S07, the first external electrode 14 and the second external electrode 15 are formed on the body 11 obtained in Step S06, to produce the multi-layer ceramic capacitor 10 shown in FIGS. 1 to 3.

In Step S07, first, an unsintered electrode material is applied so as to cover one of the end surfaces of the body 11 and then applied so as to cover the other one of the end surfaces of the body 11, the end surfaces being oriented in the X-axis direction. The applied unsintered electrode materials are subjected to baking in a reduction atmosphere or a low-oxygen partial pressure atmosphere, for example, to form base films on the body 11. On the base films baked onto the body 11, intermediate films and surface films are formed by plating such as electrolytic plating. Thus, the first external electrode 14 and the second external electrode 15 are completed.

It should be noted that part of the processing in Step S07 described above may be performed before Step S06. For example, before Step S06, the unsintered electrode material may be applied to both the end surfaces of the unsintered body 111 that are oriented in the X-axis direction, and in Step S06, the unsintered body 111 may be sintered and, simultaneously, the unsintered electrode material may be baked to form base films of the first external electrode 14 and the second external electrode 15.

### 2. Other Embodiments

While an embodiment of the present invention has been described, the present invention is not limited to the embodiment described above, and it should be appreciated that the present invention may be variously modified.

For example, in the multi-layer ceramic capacitor 10, the capacitance forming unit 18 may be divided into capacitance forming units in the Z-axis direction. In this case, in each capacitance forming unit 18, the first internal electrodes 12 and the second internal electrodes 13 only need to be alternately disposed along the Z-axis direction. In a portion where the capacitance forming units 18 are next to each other, the first internal electrodes 12 or the second internal electrodes 13 may be continuously disposed.

In addition, in the embodiment described above, the multi-layer ceramic capacitor has been described as an example of a multi-layer ceramic electronic component, but the present invention can be applied to any other multi-layer ceramic electronic components in which internal electrodes are alternatively disposed to form pairs. Examples of such multi-layer ceramic electronic components include a piezoelectric element.

What is claimed is:

1. A multi-layer ceramic capacitor, comprising:
a multi-layer comprising:
internal electrodes and dielectric layers alternately laminated,
the internal electrodes having ends protruding beyond the dielectric layers in surface directions thereof; and
side protective layers configured of a dielectric and disposed to cover side faces of the multi-layer, the side protective layers each having spacing sections formed between the ends of the internal electrodes.

2. The multi-layer ceramic capacitor according to claim 1, wherein the ends of the internal electrodes include oxidized areas.

3. The multi-layer ceramic capacitor according to claim 2, wherein;
the internal electrodes contain nickel;
the side protective layers contain magnesium; and
the oxidized areas of the internal electrodes include an oxide containing nickel and magnesium.

4. The multi-layer ceramic capacitor according to claim 1, wherein each of the ends protruding beyond the dielectric layers in surface directions has a length of 0.3 μm or more and 4 μm or less.

5. The multi-layer ceramic capacitor according to claim 4, wherein each of the ends protruding beyond the dielectric layers in surface directions has a length of 0.8 μm or more and 2 μm or less.
